(19) United States
(12) Patent Application Publication
(10) Pub. No.: US 2018/0328830 A1
(43) Pub. Date: Nov. 15, 2018

(54) Using Offset Parameters in Viscosity Calculations

(71) Applicant: Halliburton Energy Services, Inc., Houston, TX (US)

(72) Inventors: Li Gao, Katy, TX (US); Michael T. Pelletier, Houston, TX (US)

(73) Assignee: Halliburton Energy Services, Inc., Houston, TX (US)

(21) Appl. No.: 15/774,114

(22) PCT Filed: Oct. 4, 2016
(86) PCT No.: PCT/US16/55268

§ 371 Date: May 7, 2018

(51) Int. Cl. G01N 11/16; E21B 49/08

(52) U.S. Cl. CPC G01N 11/167; G01N 2011/0006; E21B 49/082

(57) ABSTRACT

A sensor is calibrated to determine a first offset parameter. The sensor has a boundary condition that affects the first offset parameter. A first viscosity of a first fluid is calculated using a calculated parameter adjusted by the first offset parameter. The calculated parameter is calculated from an output of the sensor being applied to the first fluid. An operational decision is made based on the calculated first viscosity.

### BACKGROUND

When working with fluid mixtures it is often necessary to measure their properties, including in particular fluid density and viscosity. Oilfield operators, for example, need such information to properly formulate production strategies for their reservoirs. Drillers need such information to tailor the performance of their drilling fluids. Pipeline operators need such information to optimize their product delivery. Hence the existence and widespread usage of densitometers and viscometers is unsurprising. Calibrating such densitometers and viscometers is a challenge.

### BRIEF DESCRIPTION OF THE DRAWINGS

FIG. 1A shows an illustrative wireline or slickline well logging system at a well site.

FIG. 1B shows an illustrative logging while drilling environment.

FIG. 2 shows an illustrative vibrating tube viscometer device.

FIG. 3A is a graph of an illustrative vibration signal.

FIG. 3B is a logarithmic scale graph of the signal's Hilbert transform.

FIG. 4 is a flow diagram of an illustrative viscometry method.

FIG. 5 is a flow diagram of a quality-factor based viscometry method.

FIG. 6 shows a power spectrum of an illustrative vibration signal.

FIG. 7 is a flow diagram of an illustrative decay-rate based viscometry method.

FIG. 8 shows plots for two measured empty tube Qm for a vibrating tube sensor as a function of temperature.

FIG. 9 is a flow diagram of a calibration procedure to determine λ_{Q} and λ_{τ}.

FIG. 10 is a chart showing Q_{fi}/ρ versus \sqrt{ρη} for different standard fluids at different temperatures without offsets.

FIG. 11 is a chart showing Q_{fluid}_{_}_{offset}/ρ versus \sqrt{ρη} for different standard fluids at different temperatures after calculation and application of the offsets.

FIG. 12 is a flow diagram of a viscometry method using offsets.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Further, while this disclosure describes a land-based wireline or slickline system and a land-based drilling system, it will be understood that the equipment and techniques described herein are applicable in sea-based systems, multi-lateral wells, all types of production systems, all types of rigs, measurement while drilling (“MWD”)/logging while drilling (“LWD”) environments, wired drillpipe environments, coiled tubing (wired and unwired) environments, wireline environments, and similar environments.

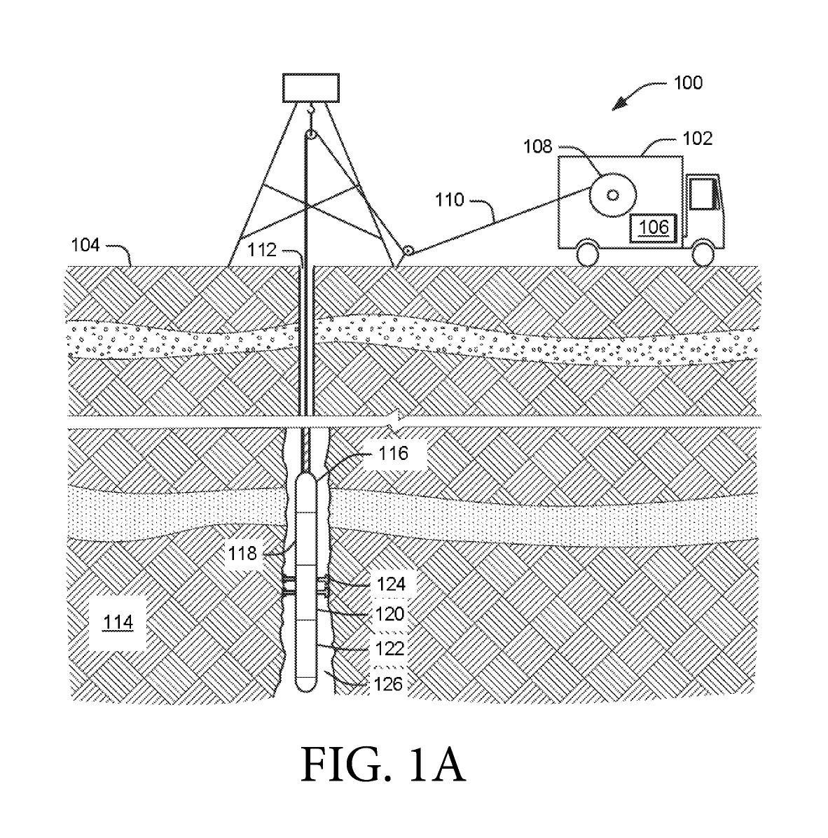

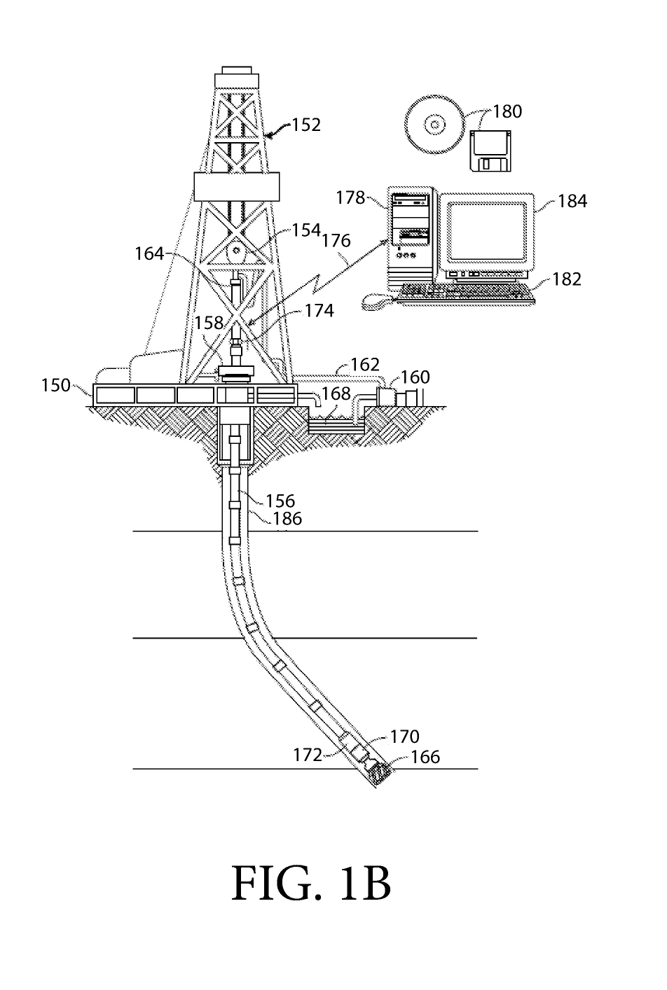

To provide some context for the disclosure, FIG. 1A shows an illustrative wireline or slickline well logging system 100 (greatly simplified for illustration) at a well site. A logging truck or skid 102 on the earth's surface 104 houses a data gathering system 106 and a winch 108 from which a cable 110 extends into a borehole 112 to a sub-surface formation 114. In one embodiment, the cable 110 suspends a logging toolstring 116 within the borehole 112 to measure formation data as the logging toolstring 116 is raised or lowered by the wireline 110. In one embodiment, the logging toolstring 116 includes a first downhole logging tool 118, a second downhole logging tool 120, and a third downhole logging tool 122. In one embodiment, the second downhole logging tool 120 is a formation testing tool to collect data about fluid extracted from sub-surface formations, such as formation 114.

The data gathering system 106 receives data from the downhole logging tools 118, 120, 122 and sends commands to the downhole logging tools 118, 120, 122. In one embodiment the data gathering system 106 includes input/output devices, memory, storage, and network communication equipment, including equipment necessary to connect to the Internet (not shown in FIG. 1A).

FIG. 1B shows an illustrative logging while drilling environment. FIG. 1B shows a drilling platform 150 supporting a derrick 152 having a traveling block 154 for raising and lowering a drill string 156. A rotary table 158 rotates the drill string 156 as it is lowered into the well. A pump 160 circulates drilling fluid through a feed pipe 162, through a kelly 164, downhole through the interior of drill string 156, through orifices in drill bit 166, back to the surface via the annulus around drill string 156, and into a retention pit 168.

The drill bit 166 is just one component of a bottom-hole assembly that typically includes one or more drill collars 170 (thick-walled steel pipe) to provide weight and rigidity. Some of these drill collars 170 may include additional tools, such as logging instruments to gather measurements of various formation and borehole fluid parameters. The bottom-hole assembly may further include one or more downhole tools and/or communication devices, such as telemetry sub 172. As depicted, the telemetry sub 172 is coupled to the drill collar 170 to transfer measurement data to a surface receiver 174 and/or to receive commands from the surface. Various forms of telemetry exist and may include mud pulse telemetry, acoustic telemetry, electromagnetic telemetry, or telemetry via wired pipe segments.

The telemetry signals are supplied via a communications link 176 to a computer 178 or some other form of a data processing device. Computer 178 operates in accordance with software (which may be stored on information storage media 180) and user input received via an input device 182 to process and decode the received signals. The resulting telemetry data may be further analyzed and processed by computer 178 to generate a display of useful information on a computer monitor 184 or some other form of a display device. For example, an operator could employ this system to obtain and monitor drilling parameters or formation fluid properties, such as viscosity measurements of the drilling fluid as the drilling progresses.

At intervals, the drill string is removed from the borehole to permit wireline logging, using for example the well logging system 100 illustrated in FIG. 1A. The wireline tool assembly is lowered into the borehole 186 on a cable having conductors for transporting power and telemetry signals. The tool assembly may include a fluid sampling tool to obtain samples of borehole fluids and/or formation fluids, which samples may be passed into a viscometer as described herein to measure the viscosity (and other parameters) of such fluids.

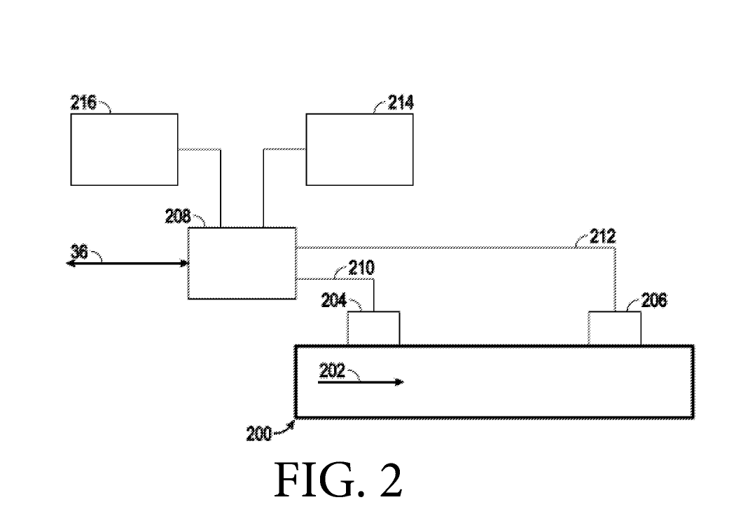

FIG. 2 shows an illustrative vibrating tube 200 viscometer device which may be used for determining a viscosity of a fluid of interest and which may be included in the first downhole logging tool 118, the second downhole logging tool 120, or the third downhole logging tool 122 in the well logging system 100 illustrated in FIG. 1A, or one of the drill collars 170 in the drilling system illustrated in FIG. 1B. For example, vibrating tube 200 may be part of a vibrating tube densitometer. Vibrating tube 200 is secured at the ends and configured to accept a flow of fluid 202 through its bore. The vibrating tube 200 is coupled to a vibration source 204 and a sensor 206. As used herein, the term “fluid” refers to a gas, liquid, or combination thereof. The vibrating tube 200 may be arranged uphole (i.e., for lab testing or calibration) or downhole (i.e., for real-time measurements and testing). The fluid 202 may flow in either direction through the vibrating tube 200.

The vibration source 204 is capable of vibrating the vibrating tube 200 and sensor 206 is capable of measuring the tube's resulting vibrations. The source and sensor may each include piezoelectric or electromagnetic transducers to transform signal energy between mechanical and electrical forms. As depicted, the vibration source 204 and sensor 206 are spaced apart axially along the vibrating tube 200. However, one of skill in the art will appreciate the numerous possible excitation/sensing variations, such as different separation spacings, different numbers of vibration sources 204 or sensors 206, or different arrangements about or inside the vibrating tube 200.

The vibration source 204 is coupled to and controlled by a processor 208 via a control signal 210. The sensor 206 is also coupled to the processor 208 and communicates a vibration signal 212 thereto corresponding to the measured vibrations of the vibrating tube 200. The processor 208 may be part of a computer (e.g., computer 178 or data gathering system 106) and arranged uphole, or may alternatively be arranged downhole and communicate with the surface via downhole telemetry methods and the communication link 176 or the cable 110. The processor 208 may include internal memory 214 for storing software and data such as the acquired vibration signal 212 or the determined fluid viscosity, or may communicate with an external memory or memory device, such as memory of another computer or a database to store such values. Additionally, the computer may be directly or indirectly coupled to a display device 216, such as computer monitor 184 (FIG. 1), to present such information or other data to a user.

In exemplary operation, the fluid 202 flows through the vibrating tube 200, while the processor 208 sends a control signal 210 to the vibration source 204 to begin vibration of the vibrating tube 200. The processor may simultaneously read the vibration signal 212 measured by the sensor 206. As explained in further detail below, the processor 208 may then calculate the fluid density and viscosity.

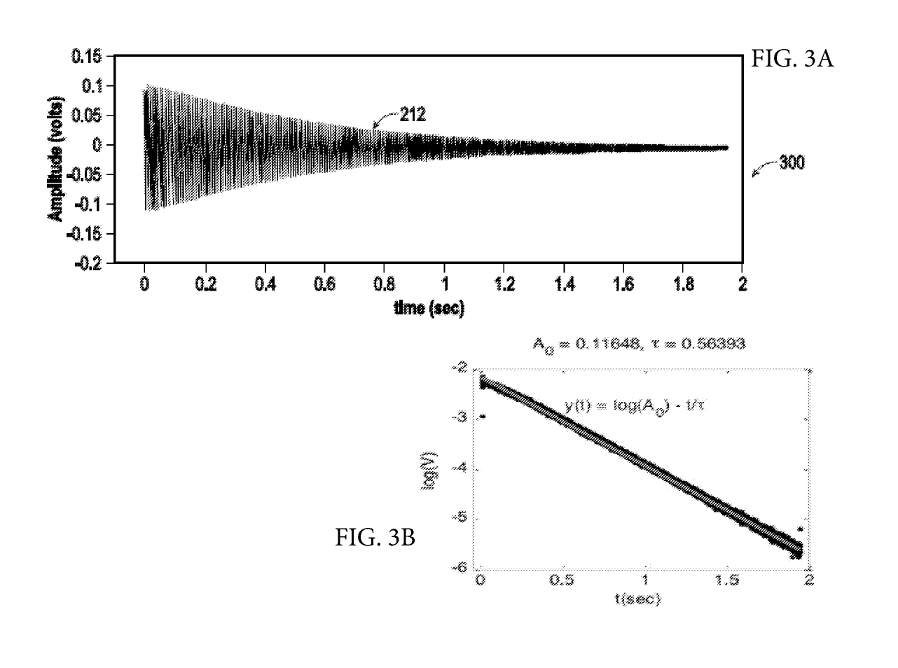

FIG. 3A is a graph 300 of an illustrative vibration signal 212 as measured by the sensor 206 in response to an excitation pulse from the vibration source 204. The Y-axis of the graph represents amplitude of the vibration signal 212 in Volts and the X-axis represents time of measurement in seconds. As depicted, the vibration signal 212 is measured for approximately 2 seconds. The vibrating tube 200 continues to resonate even after the vibration mechanism ceases stimulating vibrations (at approximately 0 seconds), with the resonating vibrations decreasing in strength as time progresses and energy dissipates. Thus, as depicted, the vibration signal 212 amplitude is largest at 0 seconds and decreases in amplitude as time progresses.

FIG. 3B is a graph of the Hilbert transform of the vibration signal, on a logarithmic scale. The Hilbert transform yields the vibration signal's envelope, which as can be seen from FIGS. 3A and 3B, has an exponential decay. One way to determine the time constant of the exponential decay is to fit a line to the logarithm of the Hilbert transform, the y-intercept of the fitted line indicating the initial amplitude A0 of the vibration signal envelope, and the slope of the fitted line indicating the time constant τ, which is representative of the energy loss rate. The amplitude and time constant derived from the fitted line in FIG. 3B are 0.116 and 0.564, respectively. An alternative approach for measuring the energy loss rate measures the width of the vibration peak in the frequency spectrum and uses it to derive a quality factor, as discussed in greater detail below.

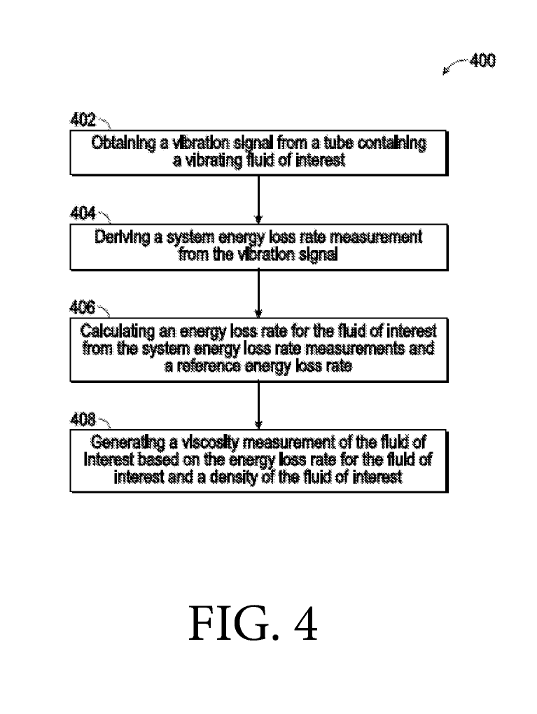

FIG. 4 is a flow diagram of an illustrative method 400 for determining a fluid of interest viscosity. The method 400 may be stored in a non-transitory computer readable information storage medium and executed by processor (e.g., processor 208 of FIG. 2) and/or computer (e.g., data gathering system 106 or computer 38 of FIG. 1B). In general, a tube (e.g., vibrating tube 200 of FIG. 2) is filled with a fluid of interest and a vibration mechanism vibrates the tube. The resulting tube vibrations are measured by a sensor which generates and conveys a vibration signal measurement to a computer, as at block 402. In some embodiments, the processor may sweep the vibration frequency to measure a response spectrum and determine a resonant frequency of the tube, as may be used to determine the fluid density (discussed below).

At block 404, a system energy loss rate measurement is derived from the vibration signal. Such system energy loss rate measurement may be expressed as a quality factor Qₘ or time decay constant τₘ. At block 406, the processor may calculate an energy loss rate for the fluid of interest Q_{fi} or τ_{fi} accordingly from the system energy loss rate measurement and a reference energy loss rate measurement. The reference energy loss rate measurement is an energy loss rate measurement for a reference fluid (Q_{ref} or τ_{ref}) which may be determined using the same or similar tube and performing such operations and calculations in a similar fashion prior to testing the fluid of interest. Upon obtaining such measurement, the reference energy loss rate measurement may be stored in memory and read as a calibration value during future tests of the fluid of interest. Alternatively, each test of a fluid of interest may be immediately preceded or followed by a test of the reference fluid to obtain the reference energy loss rate measurements.

The fluid of interest density may be measured by the same tube and, as at block 408, the fluid of interest viscosity is generated based on the energy loss rate for the fluid of interest and the fluid of interest density. As previously mentioned, the processor may vary the vibration frequency to determine a resonant frequency used to determine the fluid viscosity. Alternatively, the fluid of interest density may be read from memory based on a prior measurement or measurement of a similar fluid.

In some embodiments, the fluid of interest viscosity may be displayed to the user (e.g., via printer, monitor, or other visual display device). The fluid of interest viscosity may additionally or alternatively be stored in the computer memory or other non-transient information storage medium for later recall.

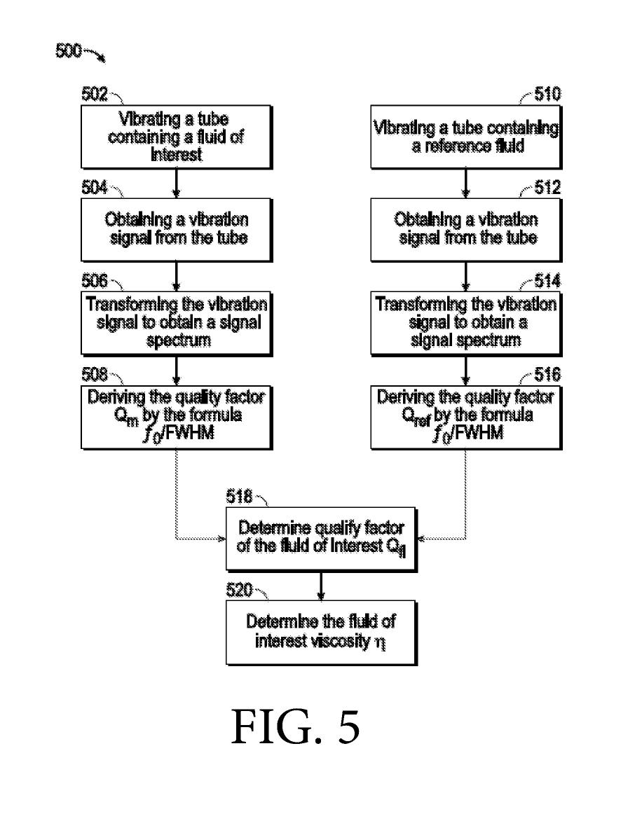

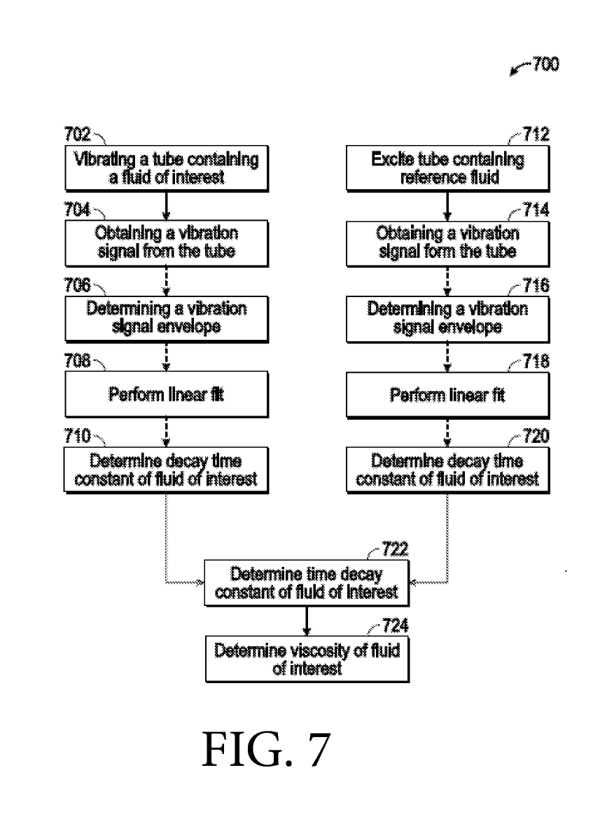

Equations 1-6 below further explain derivation of equations which may be used to determine the fluid of interest energy loss rate and viscosity. To determine the fluid of interest viscosity, a fluid of interest energy loss rate is first calculated. Equation 1 illustrates where the fluid of interest energy loss rate is a quality factor taken over time (t):

$${Q}_{fi} ( t ) = \frac{{Q}_{ref} ( t ) \times {Q}_{m} ( t )}{{Q}_{ref} ( t ) - {Q}_{m} ( t )} \qquad ( 1 )$$

wherein the system energy loss rate measurement is a quality factor taken over time Qₘ(t) and the energy loss rate measurement for a reference fluid taken over time is Q_{ref}(T), both explained in detail in connection with FIGS. 5 and 7. Equation 1 is derived from Equation 2:

$$\frac{1}{{Q}_{m} ( t )} = \frac{1}{{Q}_{fi} ( t )} + \frac{1}{{Q}_{ref} ( t )} \qquad ( 2 )$$

Equation 2 demonstrates the inverse of the system energy loss rate measurement Qₘ(t) is equal to the sum of the inverse of the fluid of interest quality factor Q_{f}(t) and the inverse of a reference fluid quality factor Q_{ref}(t). The reference fluid quality factor Q_{ref}(t) accounts for losses attributable to sources other than the fluid of interest, and includes losses caused by the vibrating tube mechanism, losses caused by the measurement electronics, and any other losses which are generally present across all fluids being tested using the same tube and/or test setup.

Isolating Q_{fi} and rearranging Equation 2 results in Equation 1, above. Using the calculated fluid of interest energy loss rate Q_{fi}, and as shown in United States Patent Publication No. 2016/0108729, Equation 3 can be used to find the fluid of interest viscosity η:

$$\frac{{Q}_{fi}}{ρ} ∝ \frac{1}{\sqrt{ρη}} \qquad ( 3 )$$

wherein ρ is a measured fluid of interest density.

As known to one of skill in the art, the quality factor Q_{fi} and time decay constant τ_{fi} for a fluid are proportionally related. Thus, the same analysis can be performed where the energy loss rate measurement is the fluid of interest time decay constant τ_{fi}, resulting in Equations 4 (similar to Equation 1) and 5 (similar to Equation 3):

$$\begin{matrix}{τ}_{fi} ( t ) = \frac{{τ}_{ref} ( t ) \times {τ}_{m} ( t )}{{τ}_{ref} ( t ) - {τ}_{m} ( t )} & ( 4 ) \\ \frac{{τ}_{fi} ( t )}{ρ} ∝ \frac{1}{\sqrt{ρη}} & ( 5 )\end{matrix}$$

FIG. 5 is a flow diagram of an illustrative method 500 for determining a fluid of interest viscosity η, wherein the energy loss rate measurements is the quality factor Q_{fi}. At block 502, a tube containing a fluid of interest is vibrated by a vibrating mechanism. At block 504, similar to block 402 (FIG. 4), the tube vibrations are sensed by a sensor which generates and transmits a corresponding vibration signal to a processor or computer. The processor may then transform the vibration signal to obtain a signal spectrum. For example, the processor may perform a Fast Fourier Transform (FFT) on the vibration signal as a transformation into the frequency domain, as at block 506. In one embodiment, as at block 508, the system quality factor Qₘ may be derived by using Equation 6:

Qₘ=f₀/FWHM (6)

where f₀ is a resonance frequency of the transformed vibration signal and FWHM is the Full Width Half Max (FWHM) value.

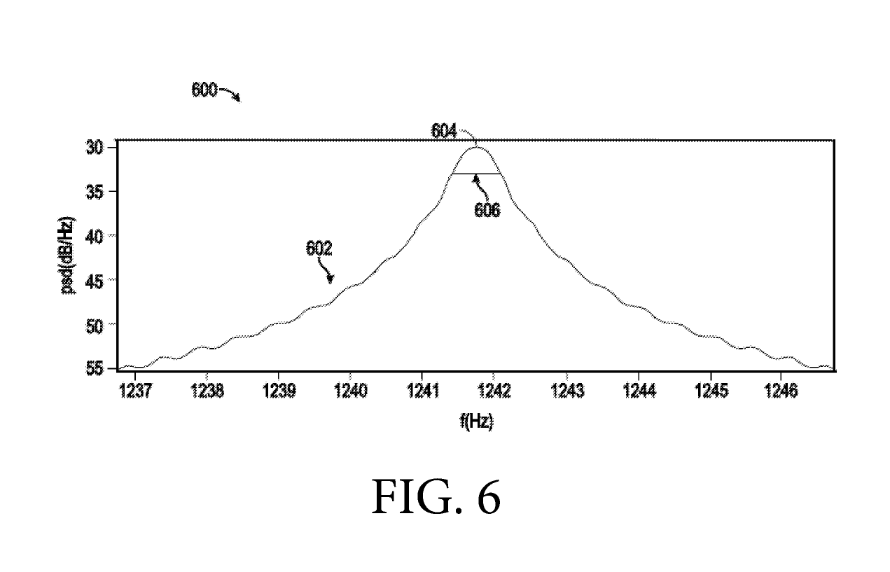

Describing the resonance frequency f₀ and FWHM in more detail is FIG. 6, which displays a graph 600 of signal spectrum 602 corresponding to a transformed time-domain vibration signal (e.g., vibration signal 212 of FIG. 2). The graph 600 includes amplitude (dB) along the Y-axis and frequency (Hz) along the X-axis. The signal spectrum 602 has a peak amplitude 604 at approximately 1241.76 Hz, thus signifying a resonance frequency f₀ of the tube being vibrated. The FWHM 606 can then be calculated as known to those skilled in the art, for example, wherein the FWHM 606 comprises the width of the spectrum peak as measured where the amplitude of the peak is half of the maximum or peak amplitude 604 of approximately −30 dB. As depicted, the FWHM 606 occurs at 10 approximately −33 dB, resulting in a FWHM of approximately 0.629.

Referring now back to FIG. 5, at block 508, the processor uses the resonance frequency f₀ and FWHM to calculate the system quality factor Qₘ using Equation 6 above. Blocks 510-516 are substantially similar to blocks 502-508, except performed with a reference fluid in the tube, thereby deriving the reference fluid quality factor Q_{ref}. However, it will be appreciated that the reference fluid quality factor Q_{ref} can alternatively be read from memory if previously calculated at the same or similar temperature. Upon obtaining both the system quality factor Qₘ and the reference fluid quality factor Q_{ref}, Equation 1 can be used to determine the fluid of interest quality factor Q_{fi}, as at block 518. At block 520, the fluid of interest viscosity η can be determined using the determined Q_{fi} and a measured fluid of interest density ρ as applied to Equation 3.

FIG. 7 is a flow diagram of an illustrative method 700 for determining a fluid of interest viscosity η, wherein the energy loss rate is the fluid of interest time decay constant τ_{fi}. Similar to the method 500, the method 700 begins by vibrating a tube containing a fluid of interest and obtaining a vibration signal from the tube, as at blocks 702 and 704. A vibration signal “envelope” is then determined at block 706. In some embodiments, the envelope may be derived by performing a Hilbert transform of the vibration signal, wherein the system time decay constant τₘ is calculated based on the transform. In other embodiments, as at block 708, a curve fit may be performed on the measured vibration signal to obtain the system time decay constant τₘ.

Blocks 712-720 are substantially similar to blocks 702-710, except for being performed with a reference fluid in the tube and finding the reference fluid time decay constant τ_{ref}. Alternatively, a previously measured reference fluid time decay constant τ_{ref} may be read from memory if previously calculated at the same or similar temperature, and used in determining the fluid of interest time decay constant τ_{fi}. Upon obtaining both the system time decay constant τₘ and the reference fluid time decay constant τ_{ref}, the fluid of interest time decay constant τ_{fi} may be calculated by using Equation 4, as at block 722. Thereafter, as at Block 724, the fluid of interest viscosity η can be determined using Equation 5 and the determined τ_{fi} and measured fluid of interest density ρ.

### Offsets and Calibration

Changes in boundary conditions defined by the vibrating tube 200 sensor, such as a change in the tension of the vibrating tube 200, variations in the initial conditions of the vibrating tube 200, variations in the mounting of the vibrating tube 200 in the vibrating tube 200 sensor, or changes in other parameters of the vibrating tube 200 sensor, may lead to an offset in Qₘ.

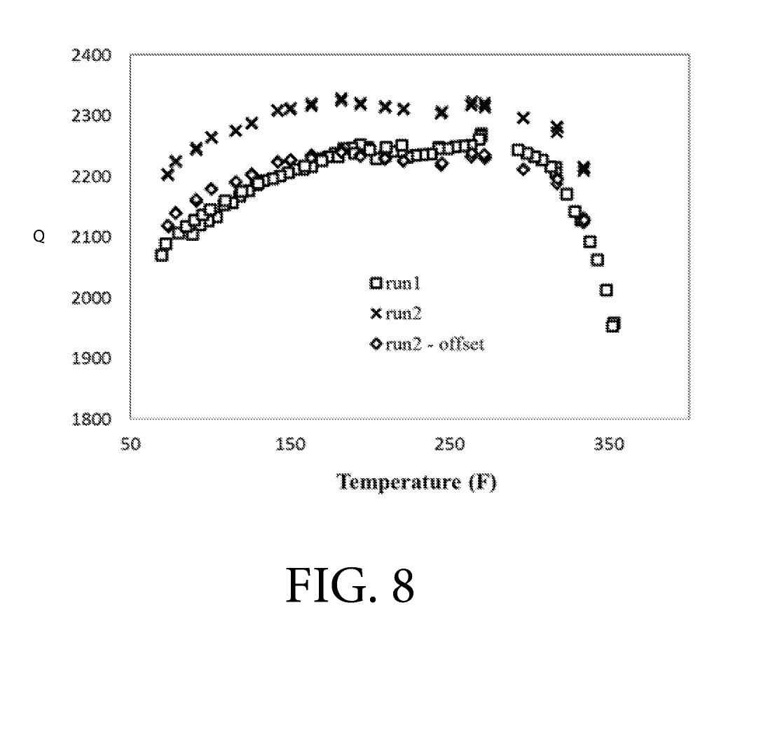

FIG. 8 shows plots for two measured empty tube Qₘ for a vibrating tube sensor as a function of temperature. The offset between the two curves is attributed to a change in boundary conditions of the vibrating tube 200 and sensor 206. In order to correctly measure viscosity using Equation (3) or Equation (5), offset parameters λ_{Q} and λ_{τ} are introduced, using air as the reference fluid, producing Equations (7) and (8):

Q_{empty}_{_}_{offset}(t)=Qₐᵢᵣ(t)+λ_{Q} (7)

τ_{empty}_{_}_{offset}(t)=τₐᵢᵣ(t)+λ_{τ} (8)

With the introduction of these two offsets, Equations (1) and (4) are modified to produce Equations (9) and (10):

$$\begin{matrix}{Q}_{{fluid}_{—} offset} ( t ) = \frac{{Q}_{{empty}_{—} offset} ( t ) \times {Q}_{m} ( t )}{{Q}_{{empty}_{—} offset} ( t ) - {Q}_{m} ( t )} & ( 9 ) \\ {τ}_{{fluid}_{—} offset} ( t ) = \frac{{τ}_{{empty}_{—} offset} ( t ) \times {τ}_{m} ( t )}{{τ}_{{empty}_{—} offset} ( t ) - {τ}_{m} ( t )} & ( 10 )\end{matrix}$$

and Equations (3) and (5) are modified to produce Equations (11) and (12):

$$\begin{matrix}\frac{{Q}_{{fluid}_{—} offset}}{ρ} ∝ \frac{1}{\sqrt{ρη}} & ( 11 ) \\ \frac{{τ}_{{fluid}_{—} offset}}{ρ} ∝ \frac{1}{\sqrt{ρη}} & ( 12 )\end{matrix}$$

The offsets (λ_{Q} and λ_{τ}) are calibration constants. Once determined, they remain constant, unless the vibrating tube 200 and/or sensor 206 change, for example as the result of the vibrating tube 400 and/or sensor 206 being disassembled and reassembled. In one or more embodiments, a re-calibration to determine a new set of offsets is performed when such a change is detected or suspected, at regular calibration intervals, or in accordance with a maintenance schedule.

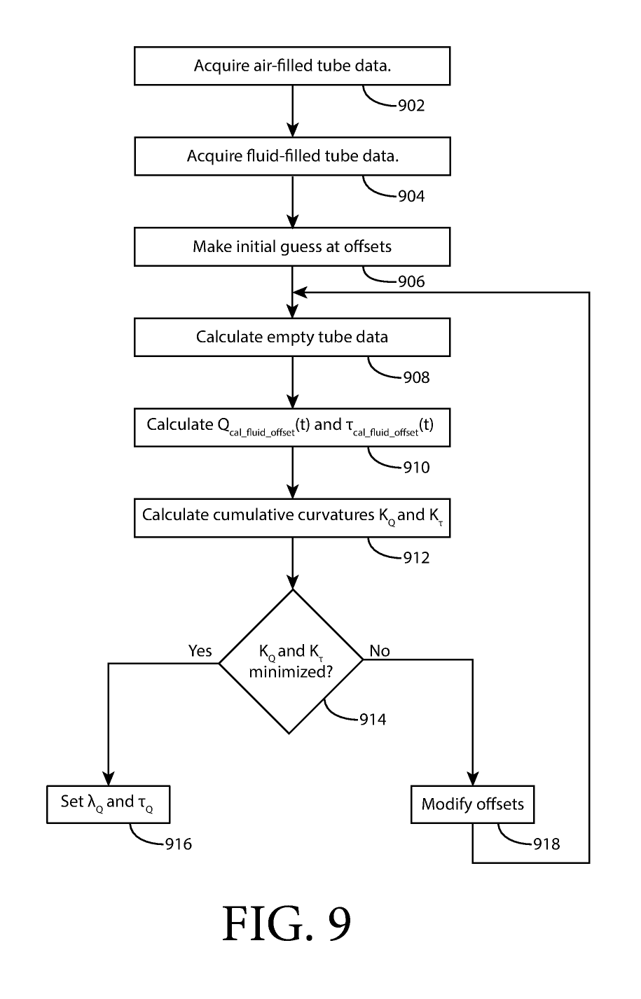

FIG. 9 is a flow diagram a calibration procedure to determine λ_{Q} and λ_{τ}. First, air-filled tube data Q_{cal}_{_}ₐᵢᵣ(t) and τ_{cal}_{_}ₐᵢᵣ(t) are acquired (block 902). To do this, the vibrating tube 200 is emptied and cleaned of all contaminants. The resonant frequency f₀ of the empty vibrating tube 200 is determined by applying a signal across a range of frequencies from the vibration source 204 to the vibrating tube 200 and detecting the resulting vibrations using the sensor 206. The range of frequencies is selected to include a predicted peak or a peak measured in a previous calibration (e.g., peak amplitude 604 in FIG. 6). The FWHM is measured in the same measurement or in a measurement using a different range of frequencies. The range of frequencies for the FWHM measurement is selected to include f₀ and at least half of the FWHM above or below f₀. Q_{cal}_{_}ₐᵢᵣ is then calculated using equation (6). This process is repeated for a range of temperatures to produce Q_{cal}_{_}ₐᵢᵣ(t).

The vibrating tube 200 is then excited with an impulse from the vibration source 204 so that the sensor 206 detects a decaying signal such as that illustrated in FIG. 3A. A Hilbert transform is performed on this signal to produce the envelope of the time domain signal. A logarithmic plot of the envelope is shown in FIG. 3B. The slope of the curve in FIG. 3B is 1/τ_{cal}_{_}ₐᵢᵣ. This process is repeated for a range of temperatures to produce τ_{cal}_{_}ₐᵢᵣ(t).

The vibrating tube is then filled with a fluid and the same processes described above to acquire fluid-filled tube data Q_{cal}_{_}ₘ(t) and τ_{cal}_{_}ₘ(t) (block 904).

Initial guesses of the offsets (λ_{Qg} and λ_{τg}) are then made (block 906). In one or more embodiments, the initial guesses are preset constants.

Empty tube data Q_{cal}_{_}_{empty}(t) and τ_{cal}_{_}_{empty}(t) are then calculated (block 908) using Equations (7) and (8) to produce Equations (12) and (13):

Q_{cal}_{_}_{empty}(t)=Q_{cal}_{_}ₐᵢᵣ(t)+λ_{Qg} (12)

τ_{cal}_{_}_{empty}=τ_{cal}_{_}ₐᵢᵣ(t)+λ_{τg} (13)

Q_{cal}_{_}_{fluid}_{_}_{offset}(t) and τ_{cal}_{_}_{fluid}_{_}_{offset}(t) are then calculated (block 910) using Equations (9) and (10) to produce Equations (14) and (15):

$$\begin{matrix}{Q}_{{cal}_{—} {fluid}_{—} offset} ( t ) = \frac{{Q}_{{cal}_{—} empty} ( t ) \times {Q}_{{cal}_{—} m} ( t )}{{Q}_{{cal}_{—} empty} ( t ) - {Q}_{{cal}_{—} m} ( t )} & ( 14 ) \\ {τ}_{{cal}_{—} {fluid}_{—} offset} ( t ) = \frac{{τ}_{{cal}_{—} empty} ( t ) \times {τ}_{{cal}_{—} m} ( t )}{{τ}_{{cal}_{—} empty} ( t ) - {Q}_{{τ}_{—} m} ( t )} & ( 15 )\end{matrix}$$

Cumulative curvatures, K_{Q} and K_{τ}, are then calculated (block 912) using equations (16) and (17) shown below:

$${K}_{Q} ( {λ}_{Q} ) = \int \vert \frac{{d}^{2} {y}_{Q}}{{dx}^{2}} \vert \qquad ( 16 )$$

where:

$${y}_{Q} = \frac{{Q}_{{cal}_{—} {fluid}_{—} offset} ( t )}{ρ} \\ x = \frac{1}{\sqrt{ρη}} , and \\ {K}_{τ} ( {λ}_{τ} ) = \int \vert \frac{{d}^{2} {y}_{τ}}{{dx}^{2}} \vert \qquad ( 17 )$$

where:

$${y}_{τ} = \frac{{τ}_{{cal}_{—} {fluid}_{—} offset} ( t )}{ρ}$$

$$x = \frac{1}{\sqrt{ρη}}$$

and where ρ and η are the density and viscosity of the fluid tested in block 908.

If K_{Q} and K_{τ} have been minimized (“yes” branch out of block 914), the calibration process ends and λ_{Q} and λ_{τ} are set (block 916).

If K_{Q} and K_{τ} have not been minimized (“no” branch out of block 914), the offsets are modified (block 918) and blocks 908, 910, 912, and 914 are repeated.

### Experimental Proof of Concept

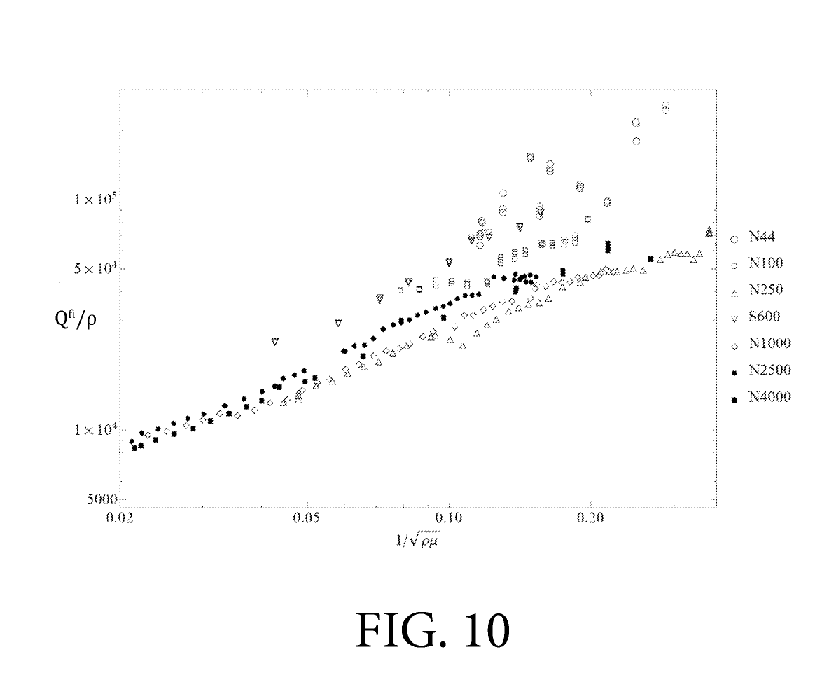

FIG. 10 is a chart showing Q_{fi}/ρ versus \sqrt{ρη} (i.e., illustrating Equation (3)) for different standard fluids at different temperatures without offsets. The standard fluids and respective symbols are listed in a key on the right side of the chart. As can be seen, the data is scattered making it difficult to infer a fluid viscosity value.

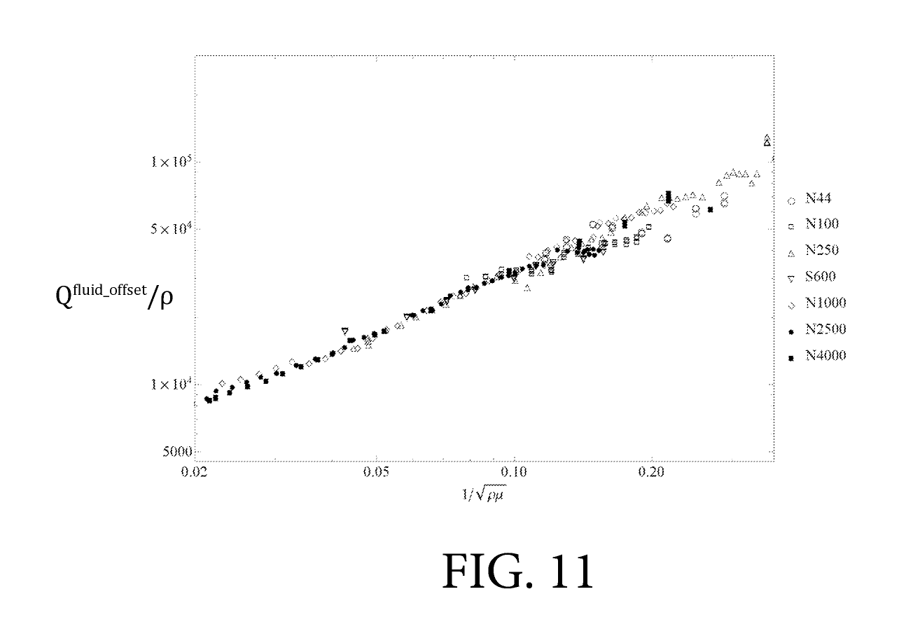

FIG. 11 is a chart showing Q_{fluid}_{_}_{offset}/ρ versus \sqrt{ρη} (i.e., illustrating Equation (12)) for different standard fluids at different temperatures after calculation and application of the offsets. Again, the standard fluids and respective symbols are listed in a key on the right side of the chart. As can be seen, the data is much closer to a line, which is what would be expected ideally, than the data in FIG. 10 and can be used to calculate fluid viscosity once fluid density ρ and Q_{f} are known.

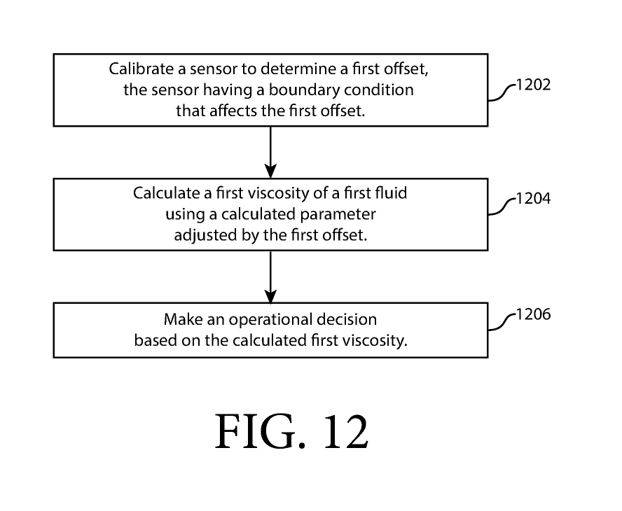

FIG. 12 is a flow diagram of a viscometry method using offsets. A sensor, such as the vibrating tube 200 sensor, is calibrated to determine a first offset parameter, such as λ_{Q} or λ_{τ}, where the sensor has a boundary condition that affects the first offset parameter (block 1202). A first viscosity of a first fluid is calculated using a calculated parameter, such as Q_{fluid}_{_}_{offset}(t) or τ_{fluid}_{_}_{offset}(t), adjusted by the first offset parameter (block 1204). The calculated parameter is calculated from an output of the sensor being applied to the first fluid. An operational decision is made based on the calculated first viscosity (block 1206).

In one aspect, a method includes calibrating a sensor to determine a first offset parameter. The sensor has a boundary condition that affects the first offset parameter. The method includes calculating a first viscosity of a first fluid using a calculated parameter adjusted by the first offset parameter. The calculated parameter is calculated from an output of the sensor being applied to the first fluid. The method includes making an operational decision based on the calculated first viscosity.

Implementations may include one or more of the following. The calculated parameter may be a quality factor Q. The calculated parameter may be a time decay constant τ. The sensor may be a density sensor. The method may include re-calibrating the sensor to determine a second offset parameter and calculating a second viscosity of a second fluid using a calculated parameter adjusted by the second offset parameter. The calculated parameter may be calculated from an output of the density sensor being applied to the second fluid. Calibrating the sensor may include calculating

$$\frac{{Q}_{it}}{{ρ}_{it}} and \frac{1}{\sqrt{{ρ}_{it} {η}_{it}}}$$

for a plurality of test fluids and a plurality of temperatures and incorporating the first offset, where Qᵢₜ is a quality factor for fluid i at temperature t, ρᵢₜ is a density of fluid i at temperature t, and ηᵢₜ is viscosity of fluid i at temperature t. The method may include adjusting the first offset so that plotting

$$\frac{{Q}_{it}}{{ρ}_{it}}$$

versus

$$\frac{1}{\sqrt{{ρ}_{it} {μ}_{it}}}$$

for all of the plurality of test fluids and all of the plurality of temperatures collapses to a single curve. The first offset may be a quality factor offset, λ_{Q}. The first offset may be a time decay offset, λ_{τ}. The first offset may be two offsets: a quality factor offset, λ_{Q}, and a time decay offset, λ_{τ}. Adjusting the first offset may produce a set of points and may include making the adjustment until a curvature of the set of points is minimized.

In one aspect, a non-transitory computer-readable medium includes a computer program. The program includes executable instructions, that, when executed, perform a method. The method includes calibrating a sensor to determine a first offset parameter. The sensor has a boundary condition that affects the first offset parameter. The method includes calculating a first viscosity of a first fluid using a calculated parameter adjusted by the first offset parameter. The calculated parameter is calculated from an output of the sensor being applied to the first fluid. The method includes making an operational decision based on the calculated first viscosity.

Implementations may include one or more of the following. The calculated parameter may be a quality factor Q. The calculated parameter may be a time decay constant τ. The sensor may be a density sensor. The method may include changing the boundary condition so that the first offset parameter is no longer valid, re-calibrating the sensor to determine a second offset parameter, and calculating a second viscosity of a second fluid using a calculated parameter adjusted by the second offset parameter. The calculated parameter may be calculated from an output of the density sensor being applied to the second fluid. Calibrating the sensor may include calculating

$$\frac{{Q}_{it}}{{ρ}_{it}} and \frac{1}{\sqrt{{ρ}_{it} {η}_{it}}}$$

for a plurality of test fluids and a plurality of temperatures and incorporating the first offset, where Qₜ is a quality factor for fluid i at temperature t, ρᵢₜ is a density of fluid i at temperature t, and ηᵢₜ is viscosity of fluid i at temperature t. The method may include adjusting the first offset so that plotting

$$\frac{{Q}_{it}}{{ρ}_{it}}$$

versus

$$\frac{1}{\sqrt{{ρ}_{it} {μ}_{it}}}$$

for all of the plurality or test fluids and all of the plurality of temperatures collapses to a single curve. The first offset may be a quality factor offset, λ_{Q}. The first offset may be a time decay offset, λ_{τ}. The first offset may be two offsets: a quality factor offset, λ_{Q}, and a time decay offset, λ_{τ}. Adjusting the first offset may produce a set of points and may include making the adjustment until a curvature of the set of points is minimized.

In one aspect, a system includes a tube that receives a fluid of interest, a sensor coupled to the tube and which receives a vibration signal from the tube 15 while the tube is being vibrated at a vibration frequency, and a processor coupled to the sensor which implements a viscosity measurement method. The viscosity measurement method includes calibrating the sensor to determine a first offset. The sensor has a boundary condition that affects the first offset. The viscosity measurement method includes calculating a first viscosity of a first fluid using a calculated parameter adjusted by the first offset. The calculated parameter is calculated from an output of the sensor being applied to the first fluid. The viscosity measurement method includes making an operational decision based on the calculated first viscosity.

Implementations may include one or more of the following. The calculated parameter may be a quality factor Q. The calculated parameter may be a time decay constant τ. The sensor may be a density sensor. The viscosity measurement method may include changing the boundary condition so that the first offset is no longer valid, re-calibrating the sensor to determine a second offset, and calculating a second viscosity of a second fluid using a calculated parameter adjusted by the second offset. The calculated parameter may be calculated from an output of the density sensor being applied to the second fluid. Calibrating the sensor may include calculating

$$\frac{{Q}_{it}}{{ρ}_{it}} and \frac{1}{\sqrt{{ρ}_{it} {η}_{it}}}$$

for a plurality of test fluids and a plurality of temperatures and incorporating an offset, where Qᵢₜ is a quality factor for fluid i at temperature t, ρᵢₜ is a density of fluid i at temperature t, and ηᵢₜ is viscosity of fluid i at temperature t. Calibrating the sensor may include adjusting the first offset so that plotting

$$\frac{{Q}_{it}}{{ρ}_{it}}$$

versus

$$\frac{1}{\sqrt{{ρ}_{it} {μ}_{it}}}$$

for all of the plurality of test fluids and all of the plurality of temperatures collapses to a single curve. The first offset may be a quality factor offset, λ_{Q}. The first offset may be a time decay offset, λ_{τ}. The first offset may be two offsets: a quality factor offset, λ_{Q}, and a time decay offset, λ_{τ}. Adjusting the first offset may produce a set of points and may include making the adjustment until a curvature of the set of points is minimized.

The word “coupled” herein means a direct connection or an indirect connection.

The word “processor” herein means is a class of devices including: computers (analog and digital), microprocessors/controllers, Application Specific Integrated Circuits (ASIC), Digital Signal Processors (DSP), and Field Gate Programmable Arrays (FGPA). All are electronic devices capable of reducing the transducer inputs to a scaled output of viscosity, if properly programed and supported (voltage, telemetry, etc.).

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
calibrating a sensor to determine a first offset parameter, the sensor having a boundary condition that affects the first offset parameter; and
calculating a first viscosity of a first fluid using a calculated parameter adjusted by the first offset parameter, the calculated parameter being calculated from an output of the sensor being applied to the first fluid.

2. The method of claim 1 wherein:
the calculated parameter is a quality factor Q or the calculated parameter is a time decay constant τ, and
the sensor is a density sensor.

3-4. (canceled)

5. The method of claim 1 further comprising:
re-calibrating the sensor to determine a second offset parameter; and
calculating a second viscosity of a second fluid using a calculated parameter adjusted by the second offset parameter, the calculated parameter being calculated from an output of the density sensor being applied to the second fluid.

6. The method of claim 1 wherein calibrating the sensor comprises:
calculating
$$\frac{{Q}_{it}}{{ρ}_{it}} and \frac{1}{\sqrt{{ρ}_{it} {η}_{it}}}$$
for a plurality of test fluids and a plurality of temperatures and incorporating the first offset, where:
Qᵢₜ is a quality factor for fluid i at temperature t,
ρᵢₜ is a density of fluid i at temperature t, and
ηᵢₜ is viscosity of fluid i at temperature t;
adjusting the first offset so that plotting
$$\frac{{Q}_{it}}{{ρ}_{it}}$$
versus
$$\frac{1}{\sqrt{{ρ}_{it} {μ}_{it}}}$$
for all of the plurality of test fluids and all of the plurality of temperatures collapses to a single curve.

7. The method of claim 6 wherein:
the first offset is a quality factor offset, λ_{Q}, or the first offset is a time decay offset, λ_{τ}, or the first offset is two offsets: a quality factor offset, λ_{Q}, and a time decay offset, λ_{τ}; and
adjusting the first offset produces a set of points and comprises making the adjustment until a curvature of the set of points is minimized.

8-10. (canceled)

11. A non-transitory computer-readable medium on which is recorded a computer program, the program comprising executable instructions, that, when executed, perform a method comprising:
calibrating a sensor to determine a first offset parameter, the sensor having a boundary condition that affects the first offset parameter; and
calculating a first viscosity of a first fluid using a calculated parameter adjusted by the first offset parameter, the calculated parameter being calculated from an output of the sensor being applied to the first fluid.

12. The non-transitory computer-readable medium of claim 11 wherein:
the calculated parameter is a quality factor Q, or the calculated parameter is a time decay constant τ; and
the sensor is a density sensor.

13-14. (canceled)

15. The non-transitory computer-readable medium of claim 11, wherein the method further comprises:
changing the boundary condition so that the first offset parameter is no longer valid;
re-calibrating the sensor to determine a second offset parameter; and
calculating a second viscosity of a second fluid using a calculated parameter adjusted by the second offset parameter, the calculated parameter being calculated from an output of the density sensor being applied to the second fluid.

16. The non-transitory computer-readable medium of claim 11 wherein calibrating the sensor comprises:
calculating
$$\frac{{Q}_{it}}{{ρ}_{it}} and \frac{1}{\sqrt{{ρ}_{it} {η}_{it}}}$$
for a plurality of test fluids and a plurality of temperatures and incorporating the first offset, where:
Qᵢₜ is a quality factor for fluid i at temperature t,
ρᵢₜ is a density of fluid i at temperature t, and
ηᵢₜ is viscosity of fluid i at temperature t;
adjusting the first offset so that plotting
$$\frac{{Q}_{it}}{{ρ}_{it}}$$
versus
$$\frac{1}{\sqrt{{ρ}_{it} {μ}_{it}}}$$
for all of the plurality of test fluids and all of the plurality of temperatures collapses to a single curve.

17. The non-transitory computer-readable medium of claim 16 wherein:
the first offset is a quality factor offset, λ_{Q}, or the first offset is a time decay offset, λ_{τ}, or the first offset is two offsets: a quality factor offset, λ_{Q}, and a time decay offset, λ_{τ}.

18-19. (canceled)

20. The non-transitory computer-readable medium of claim 16 wherein adjusting the first offset produces a set of points and comprises making the adjustment until a curvature of the set of points is minimized.

21. A system comprising:
a tube that receives a fluid of interest;
a sensor coupled to the tube and which receives a vibration signal from the tube 15 while the tube is being vibrated at a vibration frequency;
a processor coupled to the sensor which implements a viscosity measurement method comprising:
calibrating the sensor to determine a first offset, the sensor having a boundary condition that affects the first offset; and
calculating a first viscosity of a first fluid using a calculated parameter adjusted by the first offset, the calculated parameter being calculated from an output of the sensor being applied to the first fluid.

22. The system of claim 21 wherein:
the calculated parameter is a quality factor Q or the calculated parameter is a time decay constant τ.

23. (canceled)

24. The system of claim 21 wherein the sensor is a density sensor.

25. The system of claim 21 wherein the viscosity measurement method further comprises:
changing the boundary condition so that the first offset is no longer valid;
re-calibrating the sensor to determine a second offset; and
calculating a second viscosity of a second fluid using a calculated parameter adjusted by the second offset, the calculated parameter being calculated from an output of the density sensor being applied to the second fluid.

26. The system of claim 21 wherein calibrating the sensor comprises:
calculating
$$\frac{{Q}_{it}}{{ρ}_{it}} and \frac{1}{\sqrt{{ρ}_{it} {η}_{it}}}$$
for a plurality of test fluids and a plurality of temperatures and incorporating and offset, where:
Qᵢₜ is a quality factor for fluid i at temperature t,
ρᵢₜ is a density of fluid i at temperature t, and
ηᵢₜ is viscosity of fluid i at temperature t;
adjusting the first offset so that plotting
$$\frac{{Q}_{it}}{{ρ}_{it}}$$
versus
$$\frac{1}{\sqrt{{ρ}_{it} {μ}_{it}}}$$
for all of the plurality of test fluids and all of the plurality of temperatures collapses to a single curve.

27. The system of claim 26 wherein the first offset is a quality factor offset, λ_{Q}.

28. The system of claim 26 wherein the first offset is a time decay offset, λ_{τ}.

29. The system of claim 26 wherein the first offset is two offsets: a quality factor offset, λ_{Q}, and a time decay offset, λ_{τ}.

30. The system of claim 26 wherein adjusting the first offset produces a set of points and comprises making the adjustment until a curvature of the set of points is minimized.
